(19) United States
(12) Patent Application Publication
(10) Pub. No.: US 2016/0103254 A1
(43) Pub. Date: Apr. 14, 2016

(54) DIFFUSION PLATE, METHOD FOR MAKING THE SAME, AND BACKLIGHT MODULE USING THE SAME

(71) Applicant: HON HAI PRECISION INDUSTRY CO., LTD., New Taipei (TW)

(72) Inventors: FENG-YUEN DAI, New Taipei (TW); CHAU-JIN HU, New Taipei (TW); KUN-CHAN WU, New Taipei (TW); JIA-MING WANG, New Taipei (TW)

(21) Appl. No.: 14/755,246

(22) Filed: Jun. 30, 2015

(30) Foreign Application Priority Data
Oct. 13, 2014 (TW) 103135421

(51) Int. Cl. G02B 5/02; B05D 1/26; F21V 8/00; B05D 1/02

(52) U.S. Cl. CPC G02B 5/0242; B05D 1/02; B05D 1/265; G02B 6/0051; G02B 5/0278; G02B 5/0268

(57) ABSTRACT

A diffusion plate includes a substrate and a diffusion layer attached to at least one surface of substrate. The diffusion layer includes an adhesive and a plurality of calcium carbonate nanoparticles dispersed in the adhesive and mainly used for diffusing light. A method for making the diffusion plate, and a backlight module using the diffusion plate are also provided.

### FIELD

The subject matter generally relates to a diffusion plate, a method for making the same, and a backlight module using the diffusion plate.

### BACKGROUND

Diffusion plates are usually employed in backlight modules. Diffusion plate can cause the light passing it to be uniformly diffused. Such a diffusion plate includes a diffusion layer having resin and a number of particles uniformly dispersed in the resin. The particles may be made of organic polymer such as polymethylmethacrylate (PMMA), poly(butyl methacrylate), polystyrene, and silicone resin.

### BRIEF DESCRIPTION OF THE DRAWINGS

Implementations of the present technology will now be described, by way of example only, with reference to the attached figures.

FIG. 1 is a diagrammatic view of an embodiment of a diffusion plate.

FIG. 2 is a flow chart of a method for making a diffusion plate.

FIG. 3 is a diagram showing a relationship between different mass percentages of calcium carbonate nanoparticles included in the diffusion plate of FIG. 1 and transmittances of the diffusion plate.

FIG. 4 is a diagram showing a relationship between different mass percentages of calcium carbonate nanoparticles included in the diffusion plate of FIG. 1 and haze values of the diffusion plate.

FIG. 5 is a diagrammatic view of a backlight module using the diffusion plate of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

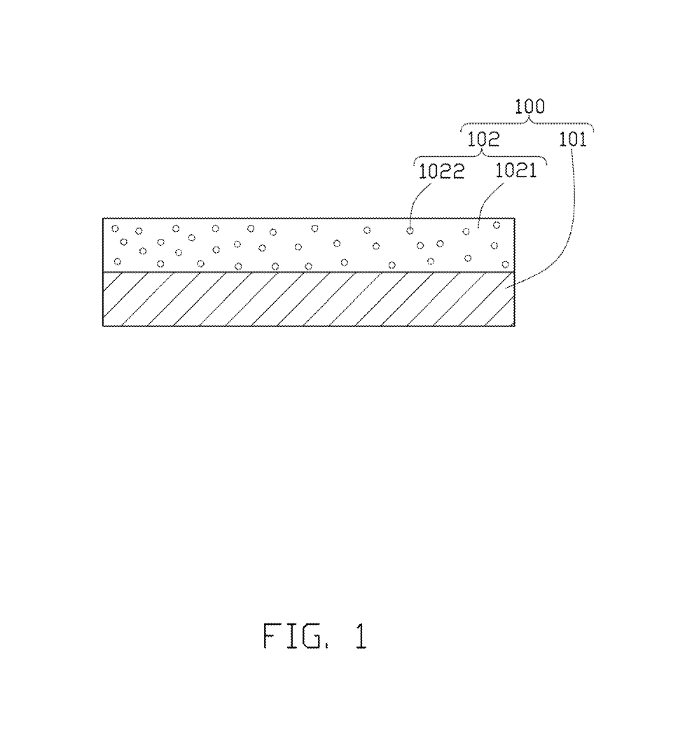

FIG. 1 illustrates an embodiment of a diffusion plate 100 including a substrate 101 and a diffusion layer 102 attached to at least one surface of the substrate 101. The diffusion layer 102 comprises an adhesive 1021 and a plurality of calcium carbonate nanoparticles 1022 uniformly dispersed in the adhesive 1021.

The substrate 101 is made of transparent resin. The transparent resin may be polycarbonate (PC), polyethylene terephthalate (PET), polyamide resin (PA), polystyrene (PS), and polymethacrylates (PMMA). The substrate 101 has a thickness of about 25 μm to about 500 μm.

The diffusion layer 102 has a thickness of about 3 μm to about 100 μm.

The adhesive 1021 has a mass percentage of no less than about 36.67% and less than 100% of the total mass of the diffusion layer 102. The calcium carbonate nanoparticles 1022 have a mass percentage of more than 0 and no more than about 63.33% of the total mass of the diffusion layer 102.

The adhesive 1021 may be selected from a group consisting of UV curable resin adhesive, ionizing radiation curable resin adhesive, thermosetting resin adhesive, and thermoplastic resin adhesive.

The calcium carbonate nanoparticles 1022 have a diameter of less than 100 nm, to improve a transmittance and a haze value of the diffusion plate 100. In at least one embodiment, the calcium carbonate nanoparticles 1022 have a diameter of about 25 nm to about 45 nm. Furthermore, since the calcium carbonate nanoparticles 1022 are uniformly dispersed in the adhesive 1021, a dimensional stability and a heat resistance of the diffusion plate 100 are improved. The calcium carbonate nanoparticles 1022 can further improve a toughness and a hardness of the diffusion plate 100.

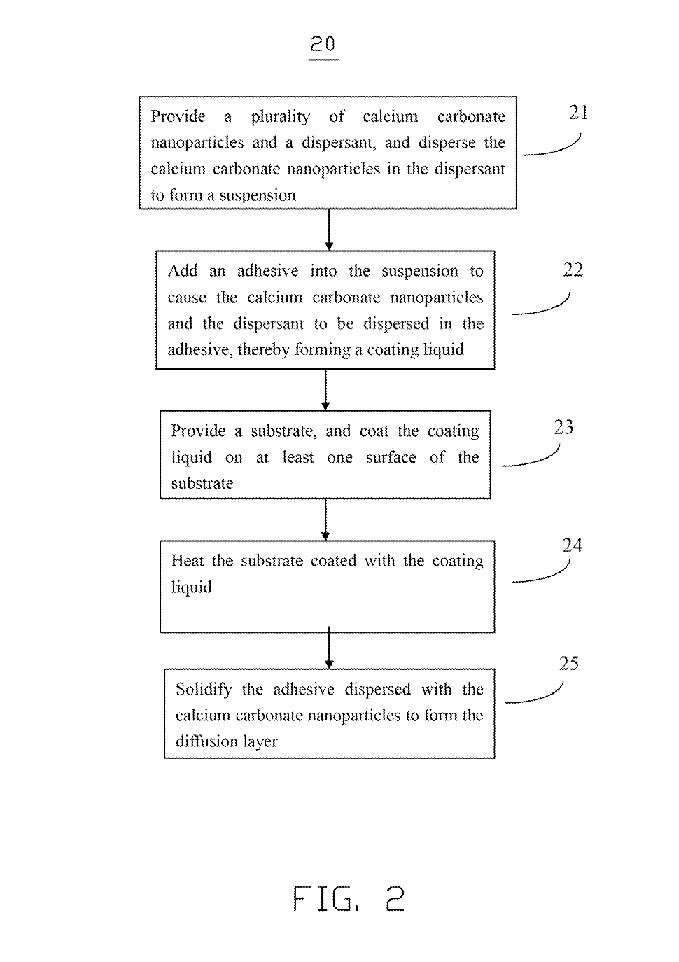

Referring to FIG. 2, a flowchart of a method for making the diffusion plate 100 is presented in accordance with an example embodiment. The example method 20 is provided by way of example, as there are a variety of ways to carry out the method. The method 20 subsequently described can be carried out using the configurations illustrated in FIG. 1, for example, and various elements of these figures are referenced in explaining example method. Each block shown in FIG. 2 represents one or more processes, methods or subroutines, carried out in the example method 20. Furthermore, the illustrated order of blocks is illustrative only and the order of the blocks can change according to the present disclosure. Additional blocks can be added or fewer blocks may be utilized, without departing from this disclosure. The example method can begin at block 21.

At block 21, a plurality of calcium carbonate nanoparticles 1022 and a dispersant are provided, and the calcium carbonate nanoparticles 1022 are uniformly dispersed in the dispersant to form a suspension. An amount of the dispersant can be varied to ensure that the calcium carbonate nanoparticles 1022 can be uniformly dispersed in the dispersant. The dispersant is a high volatile solvent selected from a group consisting of alcohols, ketone, and aromatic compounds.

At block 22, an adhesive is added into the suspension to cause the calcium carbonate nanoparticles 1022 and the dispersant to be uniformly dispersed in the adhesive, thereby forming a coating liquid. The calcium carbonate nanoparticles 1022 has a mass percentage of more than 0 and no more than about 60% of the total mass of the coating liquid.

At block 23, the substrate 101 is provided, and the coating liquid is coated on at least one surface of the substrate 101. The coating liquid may be coated on the substrate 101 by rod coating, blade coating, extrusion coating, spraying, or drop casting.

At block 24, the substrate 101 coated with the coating liquid is heated to evaporate the dispersant in the coating liquid. In at least one embodiment, the substrate 101 with the coating liquid is heated at a temperature of about 60 degrees to about 120 degrees.

At block 25, the adhesive dispersed with the calcium carbonate nanoparticles 1022 is solidified to form the diffusion layer 102 on the surface of the substrate 101, thereby obtaining the diffusion plate 100. In at least one embodiment, the adhesive is UV curable resin adhesive, and is solidified by ultraviolet radiation. In another embodiment, the adhesive is ionizing radiation curable resin adhesive, and is solidified by ionizing radiation. In yet another embodiment, the adhesive is thermosetting resin adhesive, and is solidified by heating. The adhesive can also be thermoplastic resin adhesive, and is solidified under a low temperature.

### EXAMPLES

In the following examples, the substrate 101 is made of PET. The calcium carbonate nanoparticles 1022 have a diameter of 40 nm. The dispersant is butanone. The adhesive 1021 is UV curable resin adhesive. The coating liquid is coated on the surface 1011 of the substrate 101 by rod coating, and is heated at the temperature of 90 degrees after being coated. The adhesive 1021 is solidified by ultraviolet with a wavelength of about 320 nm to about 400 nm.

Table 1 illustrates weights of the calcium carbonate nanoparticles 1022 in coating liquids, the dispersant, and the adhesive 1021 in the coating liquids of different examples, and model numbers of coating rods used to coat the coating liquids of the different examples.

### Table 1

| | | | | | Mass percent- |
|---|---|---|---|---|---|
| | | | | | age of the |
| | Calcium | | | | calcium car- |
| | carbonate | | | Model number | bonate nano- |
| Exam- | nano- | Dis- | Ad- | of the | particles in |
| ple | particles | persant | hesive | coating rod | coating liquids |
| 1 | 1 g | 1 g | 18 g | R5 | 5% |
| 2 | 1 g | 1 g | 18 g | R12 | 5% |
| 3 | 1 g | 1 g | 18 g | R22 | 5% |
| 4 | 2 g | 2 g | 16 g | R5 | 10% |
| 5 | 2 g | 2 g | 16 g | R12 | 10% |
| 6 | 2 g | 2 g | 16 g | R22 | 10% |
| 7 | 3 g | 3 g | 14 g | R5 | 15% |
| 8 | 3 g | 3 g | 14 g | R12 | 15% |
| 9 | 3 g | 3 g | 14 g | R22 | 15% |
| 10 | 4 g | 4 g | 12 g | R5 | 20% |
| 11 | 4 g | 4 g | 12 g | R12 | 20% |
| 12 | 4 g | 4 g | 12 g | R22 | 20% |
| 13 | 6 g | 6 g | 8 g | R5 | 30% |
| 14 | 6 g | 6 g | 8 g | R12 | 30% |
| 15 | 6 g | 6 g | 8 g | R22 | 30% |
| 16 | 8 g | 8 g | 4 g | R5 | 40% |
| 17 | 8 g | 8 g | 4 g | R12 | 40% |
| 18 | 8 g | 8 g | 4 g | R22 | 40% |

Wherein, each of the model numbers R5, R12, and R22 of a coating rod indicate a diameter of the coating rod. The coating rod with the model number R5 has a diameter of 0.13 mm, and a wet film formed on the surface 1011 by coating the coating liquid using this coating rod (before being cured) has a thickness of 11.43 μm. The coating rod with the model number R12 has a diameter of 0.30 mm, and a wet film formed by coating the coating liquid using this coating rod has a thickness of 27.43 μm. The coating rod with the model number R22 has a diameter of 0.56 mm, and a wet film formed by coating the locating liquid using this coating rod has a thickness of 50.29 μm. That is, the greater the diameter of the coating rod, the greater the thickness of the wet film formed by coating the coating liquid using this coating rod, and the greater thickness of the diffusion layer 102.

Table 2 illustrates the transmittance and the haze value of the substrate 101 made of PET, and the transmittances and the haze values of the diffusion plates 100 of the above different examples.

TABLE 2

| | Model number of coating rod | | | | | |
|---|---|---|---|---|---|---|
| | R5 | | R12 | | R22 | |
| Mass percentage of | Trans- | | Trans- | | Trans- | |
| the nano calcium | mit- | | mit- | | mit- | |
| carbonate particles | tance | Haze | tance | Haze | tance | Haze |
| in coating liquids | (%) | (%) | (%) | (%) | (%) | (%) |
| PET | 89.21 | 1.17 | 89.21 | 1.17 | 89.21 | 1.17 |
| 5% | 88.89 | 2.97 | 88.85 | 3.26 | 88.82 | 3.35 |
| 10% | 88.82 | 5.15 | 88.71 | 7.4 | 88.32 | 8.41 |
| 15% | 88.76 | 25.45 | 88.43 | 33.28 | 87.78 | 39.37 |
| 20% | 88.69 | 56.21 | 88.32 | 62.56 | 87.22 | 69.78 |
| 30% | 88.62 | 80.44 | 88.17 | 90.24 | 86.87 | 92.08 |
| 40% | 53.48 | 99.48 | 40.45 | 99.68 | 35.03 | 99.69 |

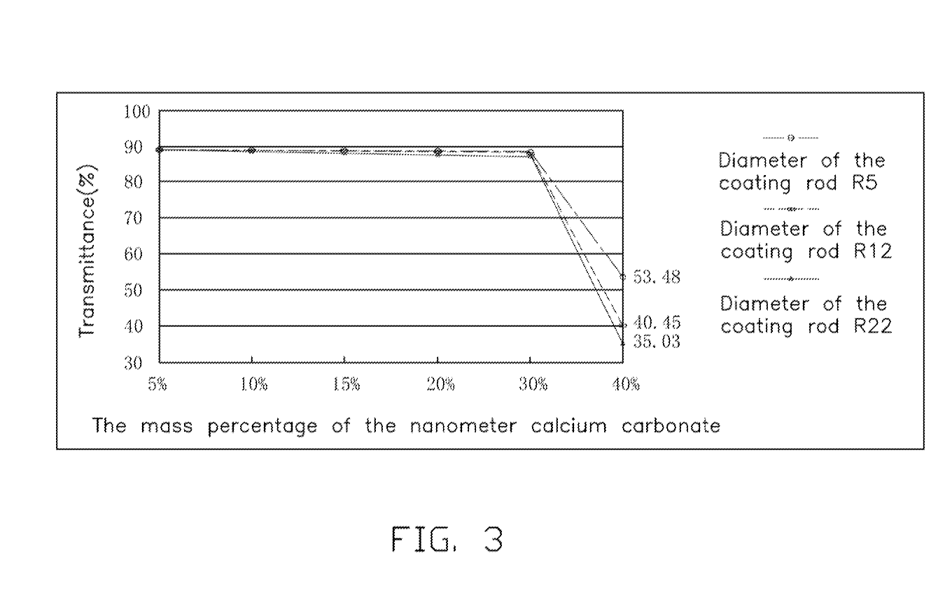

Also Referring to FIG. 3, it is known that the greater mass percentage of the calcium carbonate nanoparticles 1022 in the coating liquid, the greater mass percentage of the calcium carbonate nanoparticles 1022 in the diffusion layer 102 formed by the coating liquid. For the diffusion layers 102 including the calcium carbonate nanoparticles 1022 of a same mass percentage, the greater thickness of the diffusion layer 102, the lower transmittance of the diffusion plate 100. For the diffusion layers 102 formed by using a coating rod of a same model number, the greater the mass percentage of the calcium carbonate nanoparticles 1022 in the coating liquid, the lower transmittance of the diffusion plate 100. When the calcium carbonate nanoparticles 1022 has a mass percentage of less than 30% in coating liquid, the energy loss of the light passing through the diffusion layer 102 is lower (0.32%-2.34%), causing the diffusion plate 100 to have a transmittance (86.87-88.89%) nearly equal to the transmittance of the substrate 101 made of PET (89.21%). The transmittance of the diffusion plate 100 is decreased significantly only when the calcium carbonate nanoparticles 1022 has a mass percentage of more than 30% in the coating liquid.

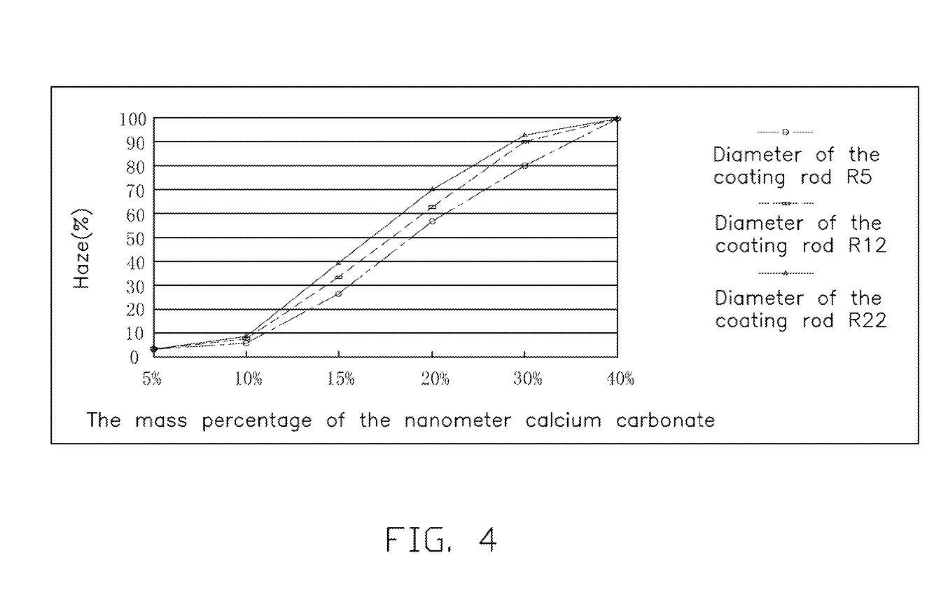

Table 2 illustrates that the diffusion plate 100 including the calcium carbonate nanoparticles 1022 has a great haze value. Also referring to FIG. 4, for the diffusion layer 102 including the calcium carbonate nanoparticles 1022 of a same percentage, the larger the thickness of the diffusion layer 102, the greater the haze value of the diffusion plate 100. For the diffusion layer 102 having a same thickness, the greater the percentage of the calcium carbonate nanoparticles 1022 in the coating liquid, the greater haze value of the diffusion plate 100.

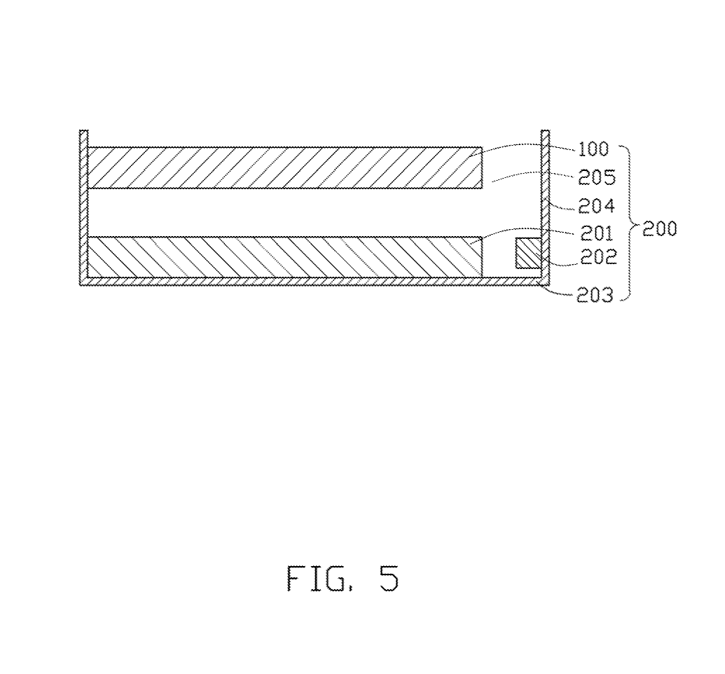

FIG. 5 illustrates an embodiment of a backlight module 200 including at least one diffusion plate 100. The backlight module 200 further includes a light guide plate 201 arranged parallel to at least one diffusion plate 100, at least one light source 202 located adjacent to an end of the light guide plate 201, a backboard 203 arranged parallel to the light guide plate 201, and a frame 204 substantially perpendicular to the backboard 203. The backboard 203 and frame 204 are engaged to define a receiving space 205 for receiving the at least one diffusion plate 100, the light guide plate 201, and the light source 202.

In this embodiment, the light guide plate 201 is secured to the backboard 203. The light source 202 is secured to the frame 204, and is aligned with the light guide plate 201. In another embodiment, the light guide plate 201 and the backboard 203 are spaced from each other. The light source 202 is located between the light guide plate 201 and the backboard 203.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. A diffusion plate comprising:
a substrate; and
a diffusion layer attached to at least one surface of the substrate, the diffusion layer comprising an adhesive and a plurality of calcium carbonate nanoparticles dispersed in the adhesive.

2. The diffusion plate of claim 1, wherein the calcium carbonate nanoparticles have a diameter of about 25 nm to about 45 nm.

3. The diffusion plate of claim 2, wherein the adhesive has a mass percentage of no less than about 36.67% and less than 100% of the total mass of the diffusion layer, and the calcium carbonate nanoparticles have a mass percentage of more than 0 and no more than about 63.33% of the total mass of the diffusion layer.

4. The diffusion plate of claim 1, wherein the substrate is made of transparent resin, the transparent resin is polycarbonate, polyethylene terephthalate, polyamide resin, polystyrene, or polymethacrylate.

5. The diffusion plate of claim 4, wherein the substrate has a thickness of about 25 μm to about 500 μm.

6. The diffusion plate of claim 4, wherein the adhesive is selected from a group consisting of UV curable resin adhesive, ionizing radiation curable resin adhesive, thermosetting resin adhesive, and thermoplastic resin adhesive.

7. The diffusion plate of claim 4, wherein the diffusion layer has a thickness of about 3 μm to about 100 μm.

8. A method for making a diffusion plate comprising:
providing a plurality of calcium carbonate nanoparticles and a dispersant, and dispersing the calcium carbonate nanoparticles in the dispersant to form a suspension;
adding an adhesive into the suspension to cause the calcium carbonate nanoparticles and the dispersant to be dispersed in the adhesive, thereby forming a coating liquid;
providing a substrate, and coating the coating liquid on at least one surface of the substrate;
heating the substrate coated with the coating liquid; and
solidifying the adhesive dispersed with the calcium carbonate nanoparticles to form the diffusion layer.

9. The method of claim 8, wherein the dispersant is a high volatile solvent selected from a group consisting of alcohols, ketone, and aromatic compounds.

10. The method of claim 8, wherein the calcium carbonate nanoparticles have a mass percentage of more than 0 and no more than about 60% of the total mass of the coating liquid.

11. The method of claim 8, wherein the calcium carbonate nanoparticles have a diameter of about 25 nm to about 45 nm.

12. The method of claim 8, wherein the adhesive is selected from a group consisting of UV curable resin adhesive, ionizing radiation curable resin adhesive, thermosetting resin adhesive, and thermoplastic resin adhesive.

13. The method of claim 8, wherein the substrate is made of transparent resin, the transparent resin is polycarbonate, polyethylene terephthalate, polyamide resin, polystyrene, or polymethacrylate.

14. The method of claim 8, wherein the coating liquid is coated on the substrate by rod coating, blade coating, extrusion coating, spraying, or drop casting.

15. The method of claim 8, wherein the heating temperature is about 60 degrees to about 120 degrees.

16. The method of claim 8, wherein the adhesive has a mass percentage of no less than about 36.67% and less than 100% of the total mass of the diffusion layer, and the calcium carbonate nanoparticles have a mass percentage of more than 0 and no more than about 63.33% of the total mass of the diffusion layer.

17. The method of claim 8, wherein the diffusion layer has a thickness of about 3 μm to about 100 μm.

18. A backlight module comprising:
a light guide plate;
at least one light source located adjacent to an end of the light guide plate; and
a diffusion plate arranged parallel to at least one light guide plate, the diffusion plate comprising:
a substrate; and
a diffusion layer attached to at least one surface of the substrate, the diffusion layer comprising an adhesive, and a plurality of calcium carbonate nanoparticles dispersed in the adhesive.
